(19) United States
(12) Patent Application Publication
(10) Pub. No.: US 2026/0005464 A1
(43) Pub. Date: Jan. 1, 2026

(54) Offset Waterproof Connector

(71) Applicant: ABB Schweiz AG, Baden (CH)

(72) Inventor: Matthew D. Cawood, DeLeon Springs, FL (US)

(73) Assignee: ABB Schweiz AG, Baden (CH)

(21) Appl. No.: 18/754,495

(22) Filed: Jun. 26, 2024

(51) Int. Cl. H01R 13/52; H01R 13/53

(52) U.S. Cl. CPC H01R 13/5202; H01R 13/53

(57) ABSTRACT

A waterproof connector device includes a backplate; a plurality of towers; and a bridge. The plurality of towers are sealingly coupled to the backplate and each tower is configured to sealingly receive a respective electrical coupling at an electrical coupling point, the plurality of towers including a first plurality of towers forming a first arrangement and a second plurality of towers forming a second arrangement, the first arrangement being offset with respect to the second arrangement. The bridge is electrically coupled to the plurality of towers for conveying current of one or more towers of the plurality of towers.

### FIELD

The present disclosure relates to waterproof connectors. In particular, the present disclosure relates to waterproof electrical connectors having an offset design.

### BACKGROUND

Conductor arrangements allow for the connection of multiple separate electrical lines to a single electrical source, such as a transformer stud. In order to provide the electrical connection between the electrical source and the electrical lines, the conductor arrangements typically include a plurality of conductors, for example in a back to back or linear arrangement, and are electrically connected to a structure that interfaces with the electrical source, such as a stud connector that interfaces with the transformer stud. However, many applications in which the conductor arrangements are installed have limited or defined spatial dimensions, such as underground transformers. As a result, increasing the number of electrical lines that can be connected to the electrical source by the conductor arrangement is often limited by the available spatial dimensions, either because the conductor arrangement will not fit within the required spatial dimensions, the conductor arrangement risks causing a short by approaching or coming into contacts with other structures, or due to the resulting difficulty of installing the conductor arrangements.

### SUMMARY

A first aspect of the present disclosure provides a waterproof connector device. The waterproof connector device includes a backplate; a plurality of towers sealingly coupled to the backplate and each tower configured to sealingly receive a respective electrical coupling at an electrical coupling point, the plurality of towers including a first plurality of towers forming a first arrangement and a second plurality of towers forming a second arrangement, the first arrangement being offset with respect to the second arrangement; and a bridge electrically coupled to the plurality of towers for conveying current of one or more towers of the plurality of towers.

In a second aspect according to an implementation of the first aspect, the first arrangement is offset with respect to the second arrangement such that the electrical coupling points of the first plurality of towers are closer to the backplate than the electrical coupling points of the second plurality of towers.

In a third aspect according to an implementation of the first and/or second aspect, the first arrangement is offset with respect to the second arrangement such that at least one tower of the plurality of towers forming the first arrangement overlaps with a space between two adjacent towers of the plurality of towers forming the second arrangement.

In a fourth aspect according to an implementation of the first, second, and/or third aspect, the first arrangement is offset with respect to the second arrangement such that at least one tower of the plurality of towers forming the first arrangement overlaps with a space between two adjacent towers of the plurality of towers forming the second arrangement.

In a fifth aspect according to an implementation of the first, second, third, and/or fourth aspect, each tower of the plurality of towers includes a central cavity and a set screw cavity, and the electrical coupling point is defined by the intersection of the central cavity and the set screw cavity.

In a sixth aspect according to an implementation of the first, second, third, fourth, and/or fifth aspect, the electrical coupling point of each tower of plurality of towers faces towards the set screw cavity of the respective tower, and the electrical coupling points of the first plurality of towers face in a same direction as the electrical coupling points of the second plurality of towers.

In a seventh aspect according to an implementation of the first, second, third, fourth, fifth, and/or sixth aspect, the backplate includes a first portion which the first arrangement is sealingly coupled to and a second portion which the second arrangement is sealingly coupled to, and the first portion is offset with respect to the second portion.

In an eighth aspect according to an implementation of the first, second, third, fourth, fifth, sixth, and/or seventh aspect, the first portion is offset with respect to the second portion in the direction of the length of the towers.

In a ninth aspect according to an implementation of the first, second, third, fourth, fifth, sixth, seventh, and/or eighth aspect, the bridge further includes an adaptor sealingly coupled to the backplate and configured to electrically couple the plurality of towers to a common electrical connection, the adaptor including a center line through which the adaptor is configured to sealingly and electrically couple to the common electrical connection, and the centerline of the adaptor is offset with respect to a center line of the backplate, the center line of the backplate located between the first arrangement and the second arrangement.

In a tenth aspect according to an implementation of the first, second, third, fourth, fifth, sixth, seventh, eighth, and/or ninth aspect, the first plurality of towers forming the first arrangement form a first linear row of towers and the second plurality of towers forming the second arrangement form a second linear row of towers.

In an eleventh aspect according to an implementation of the first, second, third, fourth, fifth, sixth, seventh, eighth, ninth, and/or tenth aspect, the first arrangement is offset with respect to the second arrangement such that the first plurality of towers are shorter than the second plurality of towers of the second arrangement.

A twelfth aspect of the present disclosure provides a system for connecting electrical couplings to an electrical connection in a waterproof manner. The system includes an electrical connection including a connection coupling; a plurality of electrical line couplings; and a connector device for electrically coupling to the connection coupling and receiving the plurality of electrical line couplings. The connector device includes a backplate; a plurality of towers sealingly coupled to the backplate and each tower configured to sealingly receive a respective electrical line coupling of the plurality of electrical line couplings at an electrical coupling point, the plurality of towers including a first plurality of towers forming a first arrangement and a second plurality of towers forming a second arrangement, the first arrangement being offset with respect to the second arrangement; and a bridge electrically coupled to the plurality of towers for conveying current between one or more towers of the plurality of towers and the electrical connection.

In a thirteenth aspect according to an implementation of the twelfth aspect, the first arrangement is offset with respect to the second arrangement such that the electrical coupling points of the first plurality of towers are closer to the backplate than the electrical coupling points of the second plurality of towers.

In a fourteenth aspect according to an implementation of the twelfth and/or thirteenth aspect, the first arrangement is offset with respect to the second arrangement such that at least one tower of the plurality of towers forming the first arrangement overlaps with a space between two adjacent towers of the plurality of towers forming the second arrangement.

In a fifteenth aspect according to an implementation of the twelfth, thirteenth, and/or fourteenth aspect, the first arrangement is offset with respect to the second arrangement such that at least one tower of the plurality of towers forming the first arrangement overlaps with a space between two adjacent towers of the plurality of towers forming the second arrangement.

In a sixteenth aspect according to an implementation of the twelfth, thirteenth, fourteenth, and/or fifteenth aspect, each tower of the plurality of towers includes a central cavity and a set screw cavity, and the electrical coupling point is defined by the intersection of the central cavity and the set screw cavity.

In a seventeenth aspect according to an implementation of the twelfth, thirteenth, fourteenth, fifteenth, and/or sixteenth aspect, the electrical coupling point of each tower of plurality of towers faces towards the set screw cavity of the respective tower, and the electrical coupling points of the first plurality of towers face in a same direction as the electrical coupling points of the second plurality of towers.

In an eighteenth aspect according to an implementation of the twelfth, thirteenth, fourteenth, fifteenth, sixteenth, and/or seventeenth aspect, the backplate includes a first portion which the first arrangement is sealingly coupled to and a second portion which the second arrangement is sealingly coupled to, and the first portion is offset with respect to the second portion.

In a nineteenth aspect according to an implementation of the twelfth, thirteenth, fourteenth, fifteenth, sixteenth, seventeenth, and/or eighteenth aspect, the bridge further includes an adaptor sealingly coupled to the backplate and configured to electrically couple the plurality of towers to a common electrical connection, the adaptor including a center line through which the adaptor is configured to sealingly and electrically couple to the electrical connection, and the centerline of the adaptor is offset with respect to a center line of the backplate, the center line of the backplate located between the first arrangement and the second arrangement.

In a twentieth aspect according to an implementation of the twelfth, thirteenth, fourteenth, fifteenth, sixteenth, seventeenth, eighteenth, and/or nineteenth aspect, the first arrangement is offset with respect to the second arrangement such that the first plurality of towers are shorter than the second plurality of towers of the second arrangement.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates an offset waterproof connector according to one or more examples of the present disclosure affixed to a transformer;

FIG. 2A illustrates a transformer stud of the transformer of FIG. 1;

FIG. 2B illustrates an offset waterproof connector configured to receive a transformer stud according to one or more examples of the present disclosure;

FIGS. 3A and 3B illustrate an offset waterproof connector having towers of different arrangements with offset lengths according to one or more examples of the present disclosure;

FIGS. 4A and 4B illustrate an offset waterproof connector having towers of different arrangements with offset positions according to one or more examples of the present disclosure;

FIG. 5 illustrates a waterproof in-line connector according to one or more examples of the present disclosure; and

FIGS. 6A and 6B illustrate an offset waterproof connector having an adaptor offset with respect to the backplate according to one or more examples of the present disclosure.

### DETAILED DESCRIPTION

Examples of the present application will now be described more fully hereinafter with reference to the accompanying FIGs., in which some, but not all, examples of the application are shown. Indeed, the application may be exemplified in different forms and should not be construed as limited to the examples set forth herein; rather, these examples are provided so that the application will satisfy applicable legal requirements. Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on”.

One or more examples of the present disclosure provide an electrical connector that can be waterproof and improve conductor connection density while maintaining installation and operational safety. For instance, in some examples, the connectors include a way to connect the connector to an electrical source (e.g., an adaptor), a backplate to which towers are physically and electrically connected, and the towers which are configured to receive electrical couplings (e.g., electrical lines). In one or more examples, these connectors provide at least one form of offset in a connector. For instance, the towers of one arrangement can be offset in length from the towers of another arrangement (e.g., the electrical coupling points of the towers of the first arrangement are closer to the backplate than the electrical coupling points of the towers of the second arrangement). Additionally, and/or alternatively, the towers of one arrangement can be offset in position with respect to the towers of another arrangement (e.g., a tower of the first arrangement overlaps with a space between two adjacent towers of the second arrangement). Additionally, and/or alternatively, an adaptor of the connector may be offset with respect to the center of the connector or a specific part thereof (e.g., the centerline of the adaptor is offset with respect to a center line of the backplate). Additionally, and/or alternatively, the backplate can include two portions, either two physically separate portions or two portions of a single united backplate, with one portion offset with respect to the other portion (e.g., a rhombic shape having the linear arrangement of towers on each side that are offset or the separate pieces offset from each other).

Offset waterproof connectors according to one or more examples of present disclosure provide waterproof connectors capable of fitting and operating within areas with spatial dimension restrictions. For example, by providing structures such as the towers in offset arrangements, the density of the connector arrangement can be increased, thereby increasing the number of spatially-restricted applications which it can be deployed, while still allowing an installer to access the hardware and sealing components. As a result, one or more examples of the present disclosure reduce installation time and difficulty, while simultaneously providing a safer and more robust waterproof connector arrangement. Moreover, one or more of the examples of the present disclosure relate to the industrial standard ANSI C119.1 and/or ANSI C119.4, and one or more examples are able to integrate any required structures and functions of those industrial standards.

Additionally, and/or alternatively, installation of the waterproof connector can be made safer by providing all setscrews capable of being engaged from the same side of the connector. This can reduce phase to phase spacing and improve the ergonomics of the installation process. Moreover, flood seals can be more easily installed for waterproof assembly.

Additionally, and/or alternatively, operation of the waterproof connector can be made safer by avoiding shorts during operation and/or busing damage resulting from cantilever loading. For example, in linear conductor arrangements, each additional electrical line adds a linearly increasing moment arm, which adds an increasingly greater stress and/or applied force during installation to the electrical common connection (e.g., transformer stud and/or transformer adaptor).

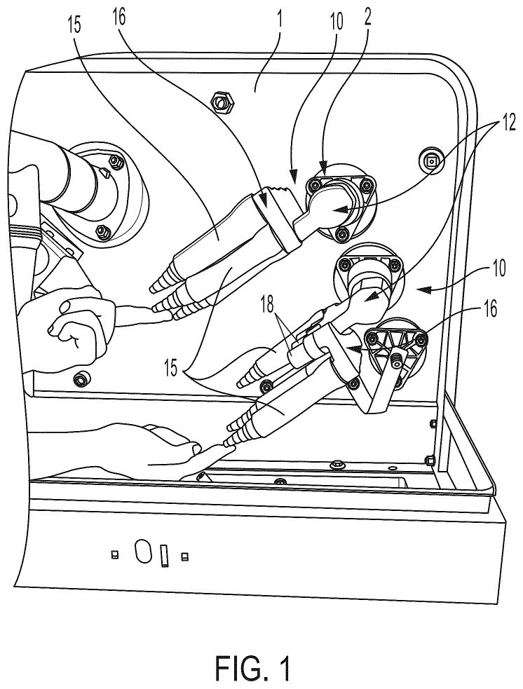

FIG. 1 provides an example of an offset waterproof connector 10 during installation. The connector 10 has been connected to the transformer 1 at the transformer connection point 2 via the adaptor 12 of the connector 10. The backplate 16, to which the towers 18 and adaptor 12 are affixed, is electrically connected to the towers 18 (e.g., conductors) and is thereby configured to help electrically couple towers 18 (which have not yet received the electrical lines in FIG. 1) to the adaptor 12 and electrical source of transformer 1. As a result, in one or more examples of the present disclosure, the backplate 16 can serve as bridge for conveying current to or from an electrical source (e.g., transformer 1) to the electrical lines connected to towers 18. Additionally, and/or alternatively, backplate 16 can serve as a bridge on its own or in combination with other current carrying structures, such as adaptor 12.

The connector 10 also includes waterproof tower sleeves 15 surrounding the towers 18, including the electrical coupling points of the towers 18. The sleeves 15 help to provide a seal for sealingly coupling the towers 18 and backplate 16. Additionally, in the example of FIG. 1, the backplate 16 has been dipped in polyvinyl chloride (PVC), provide a further sealing and waterproofing effect. With the tower sleeves 15 and/or PVC dipping of the backplate 16, the connector 10 can provide protection against fluids (e.g., rainwater, oil, gases) for various applications. Moreover, by offsetting the towers 18 and creating more space between the towers, the density of the connector arrangement can be maintained while adding the additional waterproofing materials of tower sleeves 15 and PVC.

Additionally, and/or alternatively, the connector 10 (e.g., backplate 16) can include materials such as ethylene propylene diene monomer rubber (EPDM), thermoplastic elastomers (TPEs) (also referred to as thermoplastic rubbers (TPRs)), and/or other related fluid resistant materials. The sleeves 15 can also include materials capable of exerting hoop force (e.g., compressive force) to the connector 10, such as EPDM, TPEs, TPVs, and/or other related silicon rubber materials.

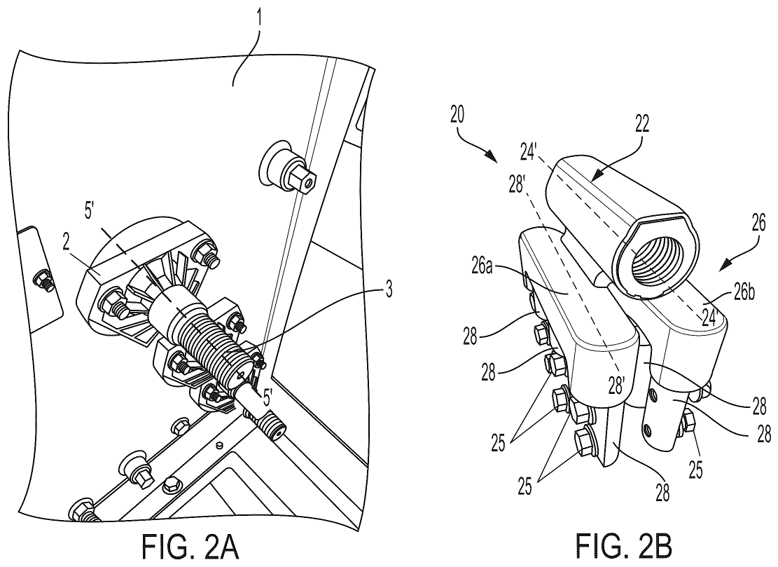

FIG. 2A illustrates an example transformer stud 3 of the transformer 1 of FIG. 1. At transformer connection point 2, the transformer 1 may have a male or female structure (e.g., male transformer stud 3) that carries current from the transformer 1. The stud 3 can be any current carrying material (e.g., copper, aluminum, steel, nickel plating), and can be threaded to assist in affixing the adaptor 12 to the transformer connection point 2. The stud 3 is a male stud, extending outwardly from the transformer connection point 2 along axis 5′ forming a transformer mounting location and configured to interface with a female adaptor.

FIG. 2B provides an example of a back to back configuration of a connector 20 having an adaptor 22 at the transformer mounting location. The adaptor 22 has a central axis 24′, with threads or another interfacing format complimentary to the transformer stud 3 that is formed (e.g., molded, casted, machined), that is configured to align with axis 5′ such that the adaptor 22 is then configured to receive transformer stud 3. Adaptor 22 can become electrically coupled to the electrical source of the transformer 1 via an electrical connection to the transformer stud 3. The adaptor 22, made of conductive materials (e.g., copper, aluminum, steel, nickel plating), then provides a bridge for carrying current between the transformer 1 and the backplates 26a, 26b and towers 28. It is noted that while the central axis 24′ of connector 20 aligns with the center of mass of adaptor 22 and stud axis 5′, the adaptor 22 in other examples may interface with the stud 3 along any other axis than the center of mass of the adaptor 22.

The backplate 26 of connector 20 is split into two separate backplates 26a and 26b, each of which define a separate arrangement of towers 28 in connector 20. Each of backplates 26a, 26b individually are physically and electrically connected to adaptor 22 and the towers 28 of their respective arrangement of towers 28, and can carry current between the adaptor 22 and the towers 28. The towers 28 are each configured to receive an electrical coupling (e.g., an electrical cable line) at least at the electrical coupling point of set screws 25, and the set screws thereby fasten the electrical coupling to the tower and help convey current between the electrical coupling and the towers 28. Each arrangement of towers 28 is commonly electrically connected to the adaptor 22 but physically connected to their respective backplate 26a or 26b. In the example of connector 20, backplate 26a is a linear backplate including a linear arrangement of towers 28, such that all of towers 28 physically connected to backplate 26a are aligned along the linear axis 28′. Within the tower arrangements of connector 20, the towers 28 of FIG. 2B are each aligned with another tower 28, such that the back of one tower 28 (with a set screw 25 head on a first side of the tower 28) faces the back of another tower 28 (with a set screw 25 head on a different side of the tower 28). As a result, the towers 28 face away from each other, with the set screws 25 pointing in opposite directions.

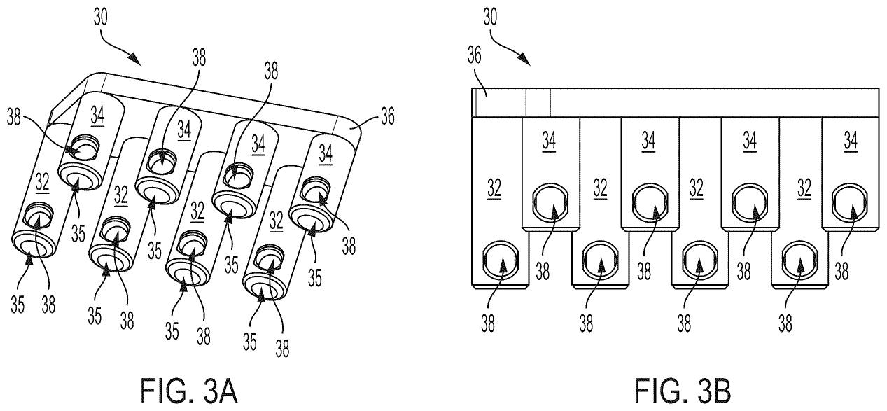

FIGS. 3A and 3B provide an example of an offset connector 30 having towers 32 in a first arrangement of towers that are longer than the towers 34 of a second arrangement of towers, creating a longer bottom arrangement of towers 32 for additional space (e.g., to engage hardware during installation). Both the first arrangement of towers 32 and the second arrangement of towers 34 are physically and electrically connected to the same backplate 36, which backplate 36 may be further connected to an electrical source via the conductors of towers 32 and convey current between towers 32, 34 and the electrical source. Both the towers 32 and 34 include a hole 38 (e.g., bore, set screw cavity, threaded nut, depression) configured to receive a set screw (e.g., set screw 25), and a hole 35 (e.g., a central cavity, bore, depression) configured to receive an electrical coupling (e.g., electrical line), which together may form an electrical coupling point at the intersection of hole 35 and 38. By providing the hole 35 and hole 38, the towers 32 and/or 34 can be made cylindrical (or another three dimensional shape such as substantially cylindrical or octagonal) allowing for easily waterproofing (e.g., sealingly coupling) the electrical coupling with waterproof sleeves, such as sleeves 15 of FIG. 1. Moreover, by providing holes 38 that are configured to receive the set screw all facing the same direction, installation can be performed efficiently by reducing the number of sides needed to be accessed during installation.

As shown in FIG. 3A, the towers 34 of the second arrangement are aligned linearly, in a linear row, and the towers 32 of the first arrangement are also aligned linearly, in a linear row. As shown in FIG. 3B, the towers 34 of the second arrangement are offset in length (e.g., shorter) with respect to the towers 32 of the first arrangement. This offset in the direction of the length of the towers further helps to ease labor during installation by improving access to the coupling points of the holes 38 configured to receive a set screw.

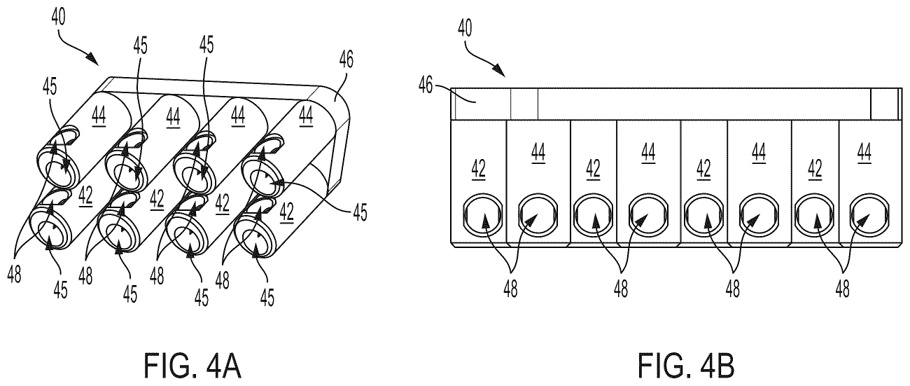

FIGS. 4A and 4B provide an example of an offset connector 40 having an offset design with towers 42, 44 of the same length. For example, the towers 42, 44 extend from the backplate 46 and are in physical and electrical connection with backplate 46. When the backplate 46 is electrically coupled to an electrical source, the towers 42, 44 are thereby electrical coupled to the electrical source via the electrical connection to the backplate 46. The towers 42, 44 include hole 48 configured to receive a set screw and hole 45 configured to receive an electrical coupling, which form an electrical coupling point (e.g., the location at which the electrical coupling is electrically connected to the tower) at the intersection of hole 35 and hole 38. However, in or more examples, the electrical coupling point be located elsewhere on the tower 42 and/or 44.

As in FIGS. 3A and 3B, the first arrangement of towers 42 is offset from the second arrangement of towers 44. For example, the towers 42 are arranged in linear row, and the towers 42 are offset in position with respect to the towers 44 above them by aligning the towers 42 of the first arrangement with the gaps between the towers 44 of the second arrangement. For instance, each tower 44 is positioned above and adjacent to a tower 42, such that each tower 44 can be positioned above the space between two adjacent towers 42. In one or more examples, the spacing between adjacent towers 44 is equal to the spacing between adjacent towers 42 to facilitate the offset. One or more examples of backplate 46, similar to backplate 36 of FIG. 3A, provide a rhombic shape corresponding to the arrangements of the towers 42, 44, where the acute angles of the rhombus correspond to the angle of offset of between towers 42 of the first arrangement and towers 44 of the second arrangement.

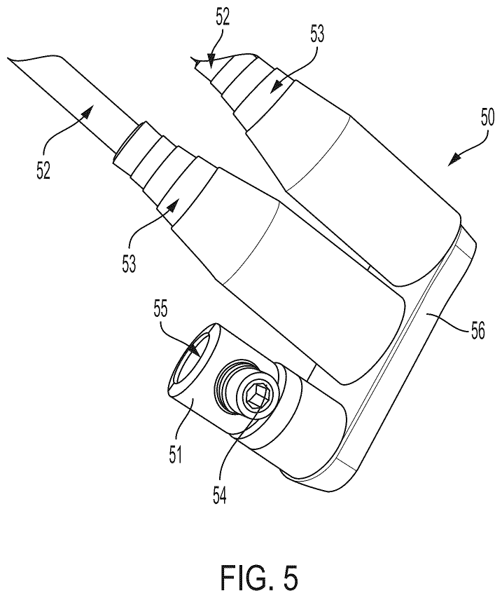

FIG. 5 provides an example of an inline type connector 50 with PVC and seals. For example, backplate 56 is physically and electrically connected to towers 51, where towers 51 are surrounded by a waterproof sleeve 53. The towers 51 have a hole 55 for receiving the electrical coupling 52 and a hole 58 for receiving the set screw 54. The set screw 54 facilitates the establishment of a physical and electrical connection of the electrical coupling 52 to the tower 51 and ultimately backplate 56. The towers 51 have a waterproof collar 59 that extends from the backplate 56 along the outside of the tower 51 and terminates at hole 58 and set screw 54 (as in FIG. 2B), although it may extend to the end of tower 51 (e.g., as in FIGS. 4A and 4B). The waterproof sleeves 53 surround the installed electrical coupling 52, along with the tower 51 and set screw 54, thereby increasing the connector 50's resistance to water damage. The structures of connector 50, including the waterproof collars 59 and waterproof sleeves 53, may be easily implemented in one or more examples of the present disclosure.

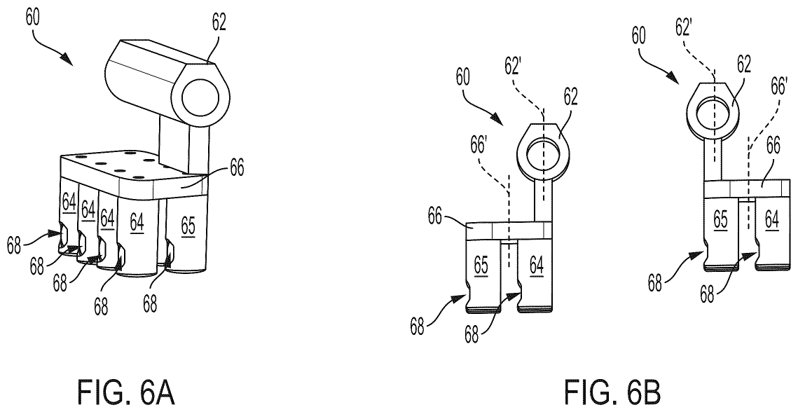

FIGS. 6A and 6B provide examples of an offset connector, similar to the connector 10 of FIG. 1, having an adaptor 62 with a centerline 62′ offset from the centerline 66′ of the backplate 66. The adaptor 62 can be sealingly, physically, and electrically connected to the backplate 66, for example, by providing the adaptor 62 with conductive material up to the connection with the backplate 66 and dipping the adaptor 62 in PVC or providing a waterproof sleeve. The backplate 66, to which the towers 64, 65 and adaptor 62 are affixed, is electrically connected to the towers and thereby helps to electrically couple towers 64, 65 to the adaptor 62 and electrical source. As a result, in one or more examples of the present disclosure, the backplate 66 serves as bridge for conveying current to or from an electrical source (e.g., a transformer) to the electrical lines that towers 64, 65 are configured to receive. Additionally, and/or alternatively, backplate 66 can serve as a bridge on its own or in combination with other current carrying structures, such as adaptor 62. The towers 64, 65 extend from the backplate 66 and are in physical and electrical connection with backplate 66. When the backplate 66 is electrically coupled to an electrical source, the towers 64, 65 are thereby electrical coupled to the electrical source via the electrical connection to the backplate 66. The towers 64, 65 include hole 68 configured to receive a set screw for fastening an electrical coupling to the respective tower of the towers 64, 65.

The towers 64 of the first arrangement are aligned in a linear row, and the towers 65 of the second arrangement (e.g., positioned underneath adaptor 62) are aligned in linear row. The first and second arrangement are position on either side of a centerline 66′ of backplate 66. The centerline 66′ can be defined in a number of ways (e.g., center of mass, center of area, center of length), but in the example of FIGS. 6A and 6B the centerline 66′ is defined by the midpoint of backplate 66 between the first and second arrangement of towers. The adaptor centerline 62′ is adjacently offset from backplate centerline 66′. In one or more applications, this offset can provide increased space management or ease of installation.

One or more examples of the present disclosure provide at least one form of offset in a connector. For instance, the towers of one arrangement can be offset in length from the towers of another arrangement (e.g., the electrical coupling points of the towers of the first arrangement are closer to the backplate than the electrical coupling points of the towers of the second arrangement), such as the towers 32 and 34 of FIGS. 3A and 3B. Additionally, and/or alternatively, the towers of one arrangement can be offset in position with respect to the towers of another arrangement (e.g., a tower of the first arrangement overlaps with a space between two adjacent towers of the second arrangement), such as the towers 42 and 44 of FIGS. 4A and 4B. Additionally, and/or alternatively, an adaptor of the connector may be offset with respect to the center of the connector or a specific part thereof (e.g., the centerline of the adaptor is offset with respect to a center line of the backplate), such as the adaptor 62 of FIGS. 6A and 6B. Additionally, and/or alternatively, the backplate can include two portions, either separate as in FIG. 2B or united as in FIG. 4A, with one portion offset with respect to the other portion (e.g., the rhombic shape having the linear arrangements offset or the separate pieces offset from each other).

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A waterproof connector device, comprising:
a backplate;
a plurality of towers sealingly coupled to the backplate and each tower configured to sealingly receive a respective electrical coupling at an electrical coupling point, the plurality of towers comprising a first plurality of towers forming a first arrangement and a second plurality of towers forming a second arrangement, wherein the first arrangement is offset with respect to the second arrangement; and
a bridge electrically coupled to the plurality of towers for conveying current of one or more towers of the plurality of towers.

2. The waterproof connecting device of claim 1, wherein the first arrangement is offset with respect to the second arrangement such that the electrical coupling points of the first plurality of towers are closer to the backplate than the electrical coupling points of the second plurality of towers.

3. The waterproof connecting device of claim 2, wherein the first arrangement is offset with respect to the second arrangement such that at least one tower of the plurality of towers forming the first arrangement overlaps with a space between two adjacent towers of the plurality of towers forming the second arrangement.

4. The waterproof connecting device of claim 1, wherein the first arrangement is offset with respect to the second arrangement such that at least one tower of the plurality of towers forming the first arrangement overlaps with a space between two adjacent towers of the plurality of towers forming the second arrangement.

5. The waterproof connecting device of claim 1, wherein each tower of the plurality of towers comprises a central cavity and a set screw cavity, and wherein the electrical coupling point is defined by the intersection of the central cavity and the set screw cavity.

6. The waterproof connecting device of claim 5, wherein the electrical coupling point of each tower of plurality of towers faces towards the set screw cavity of the respective tower, and wherein the electrical coupling points of the first plurality of towers face in a same direction as the electrical coupling points of the second plurality of towers.

7. The waterproof connecting device of claim 1, wherein the backplate comprises a first portion which the first arrangement is sealingly coupled to and a second portion which the second arrangement is sealingly coupled to, and wherein the first portion is offset with respect to the second portion.

8. The waterproof connecting device of claim 6, wherein the first portion is offset with respect to the second portion in the direction of the length of the towers.

9. The waterproof connecting device of claim 1, wherein the bridge further comprises an adaptor sealingly coupled to the backplate and configured to electrically couple the plurality of towers to a common electrical connection, the adaptor comprising a center line through which the adaptor is configured to sealingly and electrically couple to the common electrical connection, and wherein the centerline of the adaptor is offset with respect to a center line of the backplate, the center line of the backplate located between the first arrangement and the second arrangement.

10. The waterproof connecting device of claim 1, wherein the first plurality of towers forming the first arrangement form a first linear row of towers and the second plurality of towers forming the second arrangement form a second linear row of towers.

11. The waterproof connecting device of claim 1, wherein the first arrangement is offset with respect to the second arrangement such that the first plurality of towers are shorter than the second plurality of towers of the second arrangement.

12. A system for connecting electrical couplings to an electrical connection in a waterproof manner, the system comprising:
an electrical connection comprising a connection coupling;
a plurality of electrical line couplings; and
a connector device for electrically coupling to the connection coupling and receiving the plurality of electrical line couplings, the connector device comprising:
a backplate;
a plurality of towers sealingly coupled to the backplate and each tower configured to sealingly receive a respective electrical line coupling of the plurality of electrical line couplings at an electrical coupling point, the plurality of towers comprising a first plurality of towers forming a first arrangement and a second plurality of towers forming a second arrangement, wherein the first arrangement is offset with respect to the second arrangement; and
a bridge electrically coupled to the plurality of towers for conveying current between one or more towers of the plurality of towers and the electrical connection.

13. The system of claim 12, wherein the first arrangement is offset with respect to the second arrangement such that the electrical coupling points of the first plurality of towers are closer to the backplate than the electrical coupling points of the second plurality of towers.

14. The system of claim 13, wherein the first arrangement is offset with respect to the second arrangement such that at least one tower of the plurality of towers forming the first arrangement overlaps with a space between two adjacent towers of the plurality of towers forming the second arrangement.

15. The system of claim 12, wherein the first arrangement is offset with respect to the second arrangement such that at least one tower of the plurality of towers forming the first arrangement overlaps with a space between two adjacent towers of the plurality of towers forming the second arrangement.

16. The system of claim 12, wherein each tower of the plurality of towers comprises a central cavity and a set screw cavity, and wherein the electrical coupling point is defined by the intersection of the central cavity and the set screw cavity.

17. The system of claim 16, wherein the electrical coupling point of each tower of plurality of towers faces towards the set screw cavity of the respective tower, and wherein the electrical coupling points of the first plurality of towers face in a same direction as the electrical coupling points of the second plurality of towers.

18. The system of claim 12, wherein the backplate comprises a first portion which the first arrangement is sealingly coupled to and a second portion which the second arrangement is sealingly coupled to, and wherein the first portion is offset with respect to the second portion.

19. The system of claim 12, wherein the bridge further comprises an adaptor sealingly coupled to the backplate and configured to electrically couple the plurality of towers to a common electrical connection, the adaptor comprising a center line through which the adaptor is configured to sealingly and electrically couple to the electrical connection, and wherein the centerline of the adaptor is offset with respect to a center line of the backplate, the center line of the backplate located between the first arrangement and the second arrangement.

20. The system of claim 12, wherein the first arrangement is offset with respect to the second arrangement such that the first plurality of towers are shorter than the second plurality of towers of the second arrangement.
